(19) United States
(12) Patent Application Publication
(10) Pub. No.: US 2010/0246940 A1
(43) Pub. Date: Sep. 30, 2010

(54) METHOD OF GENERATING HDR IMAGE AND ELECTRONIC DEVICE USING THE SAME

(75) Inventor: Chao-Chun Lin, Taiwan (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: MICRO-STAR INTERNATIONA'L CO., LTD., Taipei County (TW)

(21) Appl. No.: 12/549,510

(22) Filed: Aug. 28, 2009

(30) Foreign Application Priority Data
Mar. 25, 2009 (TW) 098109806

(51) Int. Cl. G06K 9/40; G06K 9/62

(52) U.S. Cl. 382/159; 382/274

(57) ABSTRACT

A method of generating a high dynamic range image and an electronic device using the same are described. The method includes loading a brightness adjustment model created by a neural network algorithm; obtaining an original image; acquiring a pixel characteristic value, a first characteristic value in a first direction, and a second characteristic value in a second direction of the original image; and generating an HDR image through the brightness adjustment model according to the pixel characteristic value, the first characteristic value, and the second characteristic value of the original image. The electronic device includes a brightness adjustment model, a characteristic value acquisition unit, and a brightness adjustment procedure. The electronic device acquires a pixel characteristic value, a first characteristic value, and a second characteristic value of an original image through the characteristic value acquisition unit, and generates an HDR image from the original image through the brightness adjustment model.

### CROSS-REFERENCE TO RELATED APPLICATIONS

This non-provisional application claims priority under 35 U.S.C. §119(a) on Patent Application No(s). 098109806 filed in Taiwan, R.O.C. on Mar. 25, 2009, the entire contents of which are hereby incorporated by reference.

### BACKGROUND OF THE INVENTION

1. Field of Invention

The present invention relates to an image processing method and an electronic device using the same, and more particularly to a method of generating a high dynamic range (HDR) image and an electronic device using the same.

2. Related Art

When sensing the lights, the visual system of the human eye adjusts its sensitiveness according to the distribution of the ambient lights. Therefore, the human eye may be adapted to a too-bright or too-dark environment after a few minutes' adjustment. Currently, the working principles of the image pickup apparatus, such as video cameras, cameras, single-lens reflex cameras, and Web cameras, are similar, in which a captured image is projected via a lens to a sensing element based on the principle of pinhole imaging. However, the photo-sensitivity ranges of a photo-sensitive element such as a film, a charge coupled device sensor (CCD sensor), and a complementary metal-oxide semiconductor sensor (CMOS sensor) are different from that of the human eye, and cannot be automatically adjusted with the image. Therefore, the captured image usually has a part being too bright or too dark. FIG. 1 is a schematic view of an image with an insufficient dynamic range. The image 10 is an image with an insufficient dynamic range captured by an ordinary digital camera. In FIG. 1, an image block 12 at the bottom left corner is too dark, while an image block 14 at the top right corner is too bright. In such a case, the details of the trees and houses in the image block 12 at the bottom left corner cannot be clearly seen as this area is too dark.

In the prior art, in order to solve the above problem, a high dynamic range (HDR) image is adopted. The HDR image is formed by capturing images of the same area with different photo-sensitivities by using different exposure settings, and then synthesizing those captured images into an image comfortable to be seen by the human eye. FIG. 2 is a schematic view of synthesizing a plurality of images into an HDR image. The HDR image 20 is formed by synthesizing a plurality of images 21, 23, 25, 27, and 29 with different photo-sensitivities. This method achieves a good effect, but also has apparent disadvantages. First, the position of each captured image must be accurate, and any error may result in difficulties of the synthesis. Besides, when the images are captured, the required storage space rises from a single frame to a plurality of frames. Moreover, the time taken for the synthesis is also considered. Therefore, this method is time-consuming, wastes the storage space, and easy to practice mistakes.

### SUMMARY OF THE INVENTION

In order to solve the above problems, the present invention is a method of generating a high dynamic range (HDR) image, capable of generating an HDR image from an original image through a brightness adjustment model trained by a neural network algorithm.

The present invention provides a method of generating an HDR image. The method comprises: loading a brightness adjustment model created by a neural network algorithm; obtaining an original image; acquiring a pixel characteristic value, a first characteristic value in a first direction, and a second characteristic value in a second direction of the original image; and generating an HDR image through the brightness adjustment model according to the pixel characteristic value, the first characteristic value, and the second characteristic value of the original image.

The first direction is different from the second direction, the first direction is a horizontal direction, and the second direction is a vertical direction.

The pixel characteristic value of the original image is calculated by the following formula:

$${C}_{1} = \frac{{Y}_{ij}}{{\sum }_{i = 1}^{N} {\sum }_{j = 1}^{M} \frac{{Y}_{ij}}{N \times M}} ,$$

where C₁ is the pixel characteristic value of the original image, N is a total number of pixels in the horizontal direction of the original image, M is a total number of pixels in the vertical direction of the original image, Yᵢⱼ is a brightness value of an i^{th} pixel in the first direction and a j^{th} pixel in the second direction of the original image, and N, M, i, and j are positive integers.

The first characteristic value of the original image is calculated by the following formula:

$${C}_{{2}_{x}} = \frac{{Y}_{ij} - {Y}_{( i + x ) j}}{x} ,$$

where C₂_{ₓ} is the first characteristic value of the original image, x is a number of pixels in the first direction of the original image, Yᵢⱼ is a brightness value of an i^{th} pixel in the first direction and a j^{th} pixel in the second direction of the original image, Y₍ᵢ₊ₓ₎ⱼ is a brightness value of an (i+x)^{th} pixel in the first direction and the j^{th} pixel in the second direction of the original image, and i, j, and x are positive integers.

The second characteristic value of the original image is calculated by the following formula:

$${C}_{{2}_{y}} = \frac{{Y}_{ij} - {Y}_{i ( j + y )}}{y} ,$$

where C₂_{_{y}} is the second characteristic value of the original image, y is a number of pixels in the second direction of the original image, Yᵢⱼ is a brightness value of an i^{th} pixel in the first direction and a j^{th} pixel in the second direction of the original image, Y_{i(j+y)} is a brightness value of an i^{th} pixel in the first direction and a (j+y)^{th} pixel in the second direction of the original image, and i, j, and y are positive integers.

The brightness adjustment model is created in an external device. The creation process comprises: loading a plurality of training images; and acquiring a pixel characteristic value, a first characteristic value in a first direction, and a second characteristic value in a second direction of each of the training images, and creating the brightness adjustment model through the neural network algorithm.

The first direction is different from the second direction, the first direction is a horizontal direction, and the second direction is a vertical direction.

The pixel characteristic value of each of the training images is calculated by the following formula:

$${C}_{1} = \frac{{Y}_{ij}}{{\sum }_{i = 1}^{N} {\sum }_{j = 1}^{M} \frac{{Y}_{ij}}{N \times M}} ,$$

where C₁ is the pixel characteristic value of each of the training images, N is a total number of pixels in the horizontal direction of each of the training images, M is a total number of pixels in the vertical direction of each of the training images, Yᵢⱼ is a brightness value of an i^{th} pixel in the first direction and a j^{th} pixel in the second direction of each of the training images, and N, M, i, and j are positive integers.

The first characteristic value of each of the training images is calculated by the following formula:

$${C}_{{2}_{x}} = \frac{{Y}_{ij} - {Y}_{( i + x ) j}}{x} ,$$

where C₂_{ₓ} is the first characteristic value of each of the training images, x is a number of pixels in the first direction of each of the training images, Yᵢⱼ is a brightness value of an i^{th} pixel in the first direction and a j^{th} pixel in the second direction of each of the training images, Y₍ᵢ₊ₓ₎ⱼ is a brightness value of an (i+x)^{th} pixel in the first direction and the j^{th} pixel in the second direction of each of the training images, and i, j, and x are positive integers.

The second characteristic value of each of the training images is calculated by the following formula:

$${C}_{{2}_{y}} = \frac{{Y}_{ij} - {Y}_{i ( j + y )}}{y} ,$$

where C₂_{_{y}} is the second characteristic value of each of the training images, y is a number of pixels in the second direction of each of the training images, Yᵢⱼ is a brightness value of an i^{th} pixel in the first direction and a j^{th} pixel in the second direction of each of the training images, Y_{i(j+y)} is a brightness value of an i^{th} pixel in the first direction and a (j+y)^{th} pixel in the second direction of each of the training images, and i, j, and y are positive integers.

The neural network algorithm is a back-propagation neural network (BNN), radial basis function (RBF), or self-organizing map (SOM) algorithm.

An electronic device for generating an HDR image is adapted to perform brightness adjustment on an original image through a brightness adjustment model. The electronic device comprises a brightness adjustment model, a characteristic value acquisition unit, and a brightness adjustment procedure. The brightness adjustment model is created by a neural network algorithm. The characteristic value acquisition unit acquires a pixel characteristic value, a first characteristic value in a first direction, and a second characteristic value in a second direction of the original image. The brightness adjustment procedure is connected to the brightness adjustment model and the characteristic value acquisition unit, for generating an HDR image through the brightness adjustment model according to the pixel characteristic value, the first characteristic value, and the second characteristic value of the original image.

The first direction is different from the second direction, the first direction is a horizontal direction, and the second direction is a vertical direction.

The pixel characteristic value of the original image is calculated by the following formula:

$${C}_{1} = \frac{{Y}_{ij}}{{\sum }_{i = 1}^{N} {\sum }_{j = 1}^{M} \frac{{Y}_{ij}}{N \times M}} ,$$

where C₁ is the pixel characteristic value of the original image, N is a total number of pixels in the horizontal direction of the original image, M is a total number of pixels in the vertical direction of the original image, Yᵢⱼ is a brightness value of an i^{th} pixel in the first direction and a j^{th} pixel in the second direction of the original image, and N, M, i, and j are positive integers.

The first characteristic value of the original image is calculated by the following formula:

$${C}_{{2}_{x}} = \frac{{Y}_{ij} - {Y}_{( i + x ) j}}{x} ,$$

where C₂_{ₓ} is the first characteristic value of the original image, x is a number of pixels in the first direction of the original image, Yᵢⱼ is a brightness value of an i^{th} pixel in the first direction and a j^{th} pixel in the second direction of the original image, Y₍ᵢ₊ₓ₎ⱼ is a brightness value of an (i+x)^{th} pixel in the first direction and the j^{th} pixel in the second direction of the original image, and i, j, and x are positive integers.

The second characteristic value of the original image is calculated by the following formula:

$${C}_{{2}_{y}} = \frac{{Y}_{ij} - {Y}_{i ( j + y )}}{y} ,$$

where C₂_{_{y}} is the second characteristic value of the original image, y is a number of pixels in the second direction of the original image, Yᵢⱼ is a brightness value of an i^{th} pixel in the first direction and a j^{th} pixel in the second direction of the original image, Y_{i(j+y)} is a brightness value of an i^{th} pixel in the first direction and a (j+y)^{th} pixel in the second direction of the original image, and i, j, and y are positive integers.

The brightness adjustment model is created in an external device. The creation process comprises: loading a plurality of training images; and acquiring a pixel characteristic value, a first characteristic value in a first direction, and a second characteristic value in a second direction of each of the training images, and creating the brightness adjustment model through the neural network algorithm.

The first direction is different from the second direction, the first direction is a horizontal direction, and the second direction is a vertical direction.

The pixel characteristic value of each of the training images is calculated by the following formula:

$${C}_{1} = \frac{{Y}_{ij}}{{\sum }_{i = 1}^{N} {\sum }_{j = 1}^{M} \frac{{Y}_{ij}}{N \times M}} ,$$

where C₁ is the pixel characteristic value of each of the training images, N is a total number of pixels in the horizontal direction of each of the training images, M is a total number of pixels in the vertical direction of each of the training images, Yᵢⱼ is a brightness value of an i^{th} pixel in the first direction and a j^{th} pixel in the second direction of each of the training images, and N, M, i, and j are positive integers.

The first characteristic value of each of the training images is calculated by the following formula:

$${C}_{{2}_{x}} = \frac{{Y}_{ij} - {Y}_{( i + x ) j}}{x} ,$$

where C₂_{ₓ} is the first characteristic value of each of the training images, x is a number of pixels in the first direction of each of the training images, Yᵢⱼ is a brightness value of an i^{th} pixel in the first direction and a j^{th} pixel in the second direction of each of the training images, Y₍ᵢ₊ₓ₎ⱼ is a brightness value of an (i+x)^{th} pixel in the first direction and the j^{th} pixel in the second direction of each of the training images, and i, j, and x are positive integers.

The second characteristic value of each of the training images is calculated by the following formula:

$${C}_{{2}_{y}} = \frac{{Y}_{ij} - {Y}_{i ( j + y )}}{y} ,$$

where C₂_{_{y}} is the second characteristic value of each of the training images, y is a number of pixels in the second direction of each of the training images, Yᵢⱼ is a brightness value of an i^{th} pixel in the first direction and a j^{th} pixel in the second direction of each of the training images, Y_{i(j+y)} is a brightness value of an i^{th} pixel in the first direction and a (j+y)^{th} pixel in the second direction of each of the training images, and i, j, and y are positive integers.

The neural network algorithm is a BNN, RBF, or SOM algorithm.

According to the method of generating an HDR image and the electronic device of the present invention, an HDR image can be generated from a single image through a brightness adjustment model trained by a neural network algorithm. Thereby, the time taken for capturing a plurality of images is shortened and the space for storing the captured images is reduced. Meanwhile, the time for synthesizing a plurality of images into a single image is reduced.

### BRIEF DESCRIPTION OF THE DRAWINGS

The present invention will become more fully understood from the detailed description given herein below for illustration only, and thus are not limitative of the present invention, and wherein:

FIG. 1 is a schematic view of an image with an insufficient dynamic range;

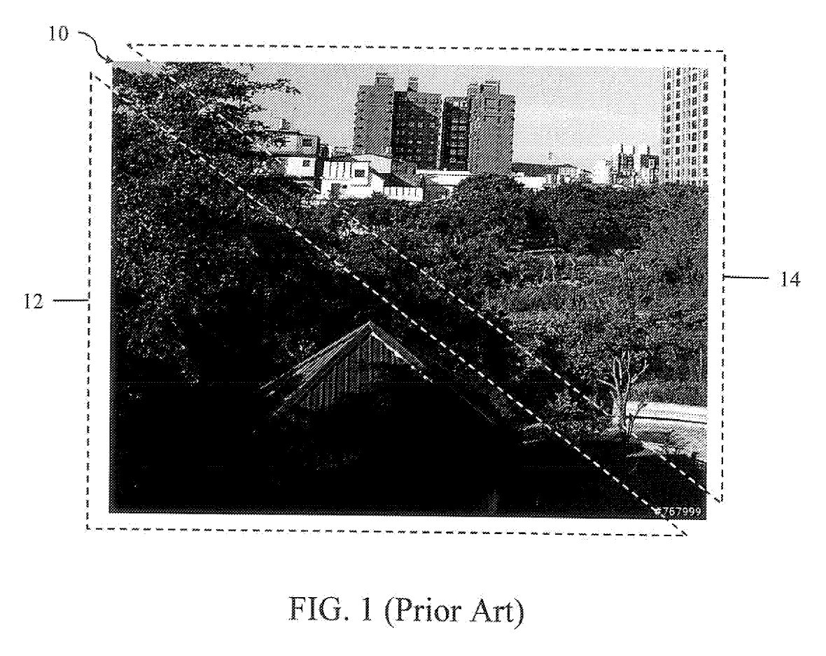

FIG. 2 is a schematic view of synthesizing a plurality of images into an HDR image;

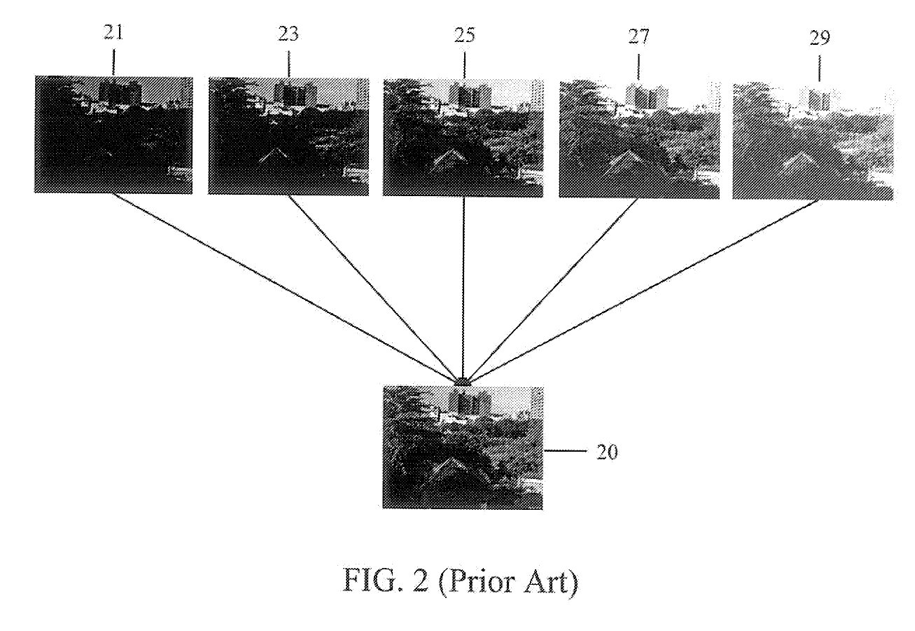

FIG. 3 is a flow chart of a method of generating an HDR image according to an embodiment of the present invention;

FIG. 4 is a flow chart of creating a brightness adjustment model according to an embodiment of the present invention;

FIG. 5 is a schematic architectural view of an electronic device for generating an HDR image according to another embodiment of the present invention;

FIG. 6 is a flow chart of creating a brightness adjustment model according to another embodiment of the present invention; and

FIG. 7 is a schematic view illustrating a BNN algorithm according to an embodiment of the present invention.

### DETAILED DESCRIPTION OF THE INVENTION

The method of generating an HDR image of the present invention is applied to an electronic device capable of capturing an image. This method can be built in a storage unit of the electronic device in the form of a software or firmware program, and implemented by a processor of the electronic device in the manner of executing the built-in software or firmware program while using its image capturing function. The electronic device may be, but not limited to, a digital camera, a computer, a mobile phone, or a personal digital assistant (PDA) capable of capturing an image.

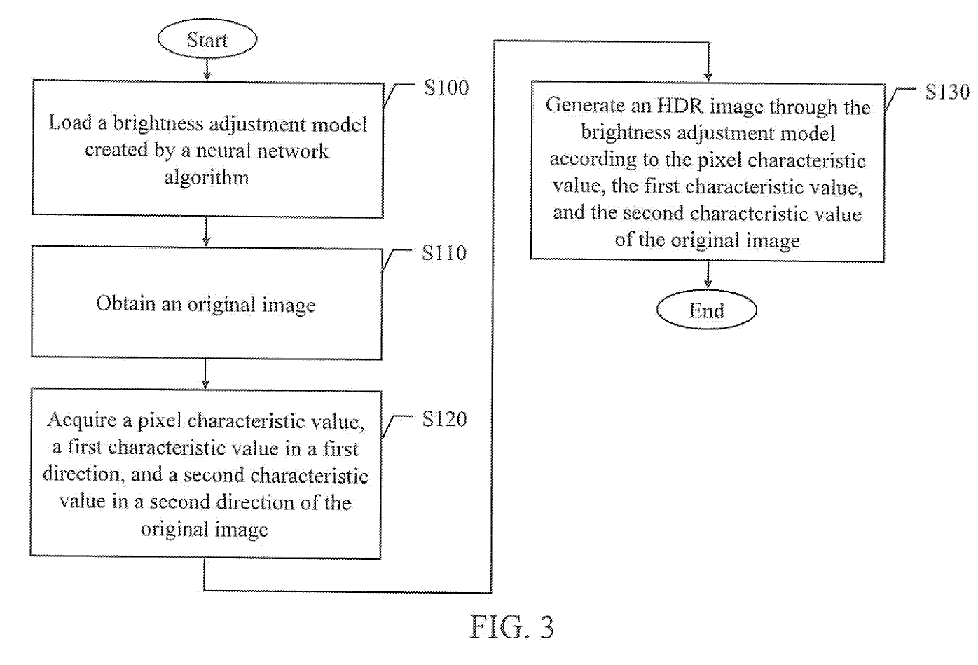

FIG. 3 is a flow chart of a method of generating an HDR image according to an embodiment of the present invention. The method comprises the following steps.

In step S100, a brightness adjustment model created by a neural network algorithm is loaded.

In step S110, an original image is obtained.

In step S120, a pixel characteristic value, a first characteristic value in a first direction, and a second characteristic value in a second direction of the original image are acquired.

In step S130, an HDR image is generated through the brightness adjustment model according to the pixel characteristic value, the first characteristic value, and the second characteristic value of the original image.

In the step S120, the first direction is different from the second direction, the first direction is a horizontal direction, and the second direction is a vertical direction. Here, the first direction and the second direction can be adjusted according to actual requirements. For example, the two directions may respectively be positive 45° and positive 135° intersected with an X-axis, or positive 30° and positive 150° intersected with the X-axis. However, the acquisition direction of the characteristic value of the original image must be consistent with the acquisition direction of the characteristic value of the training image (i.e., being the same direction).

In the step S120, the pixel characteristic value of the original image is calculated by the following formula:

$${C}_{1} = \frac{{Y}_{ij}}{{\sum }_{i = 1}^{N} {\sum }_{j = 1}^{M} \frac{{Y}_{ij}}{N \times M}} ,$$

where C₁ is the pixel characteristic value of the original image, N is a total number of pixels in the horizontal direction of the original image, M is a total number of pixels in the vertical direction of the original image, Yᵢⱼ is a brightness value of an i^{th} pixel in the first direction and a j^{th} pixel in the second direction of the original image, and N, M, i, and j are positive integers.

In the step S120, the first characteristic value of the original image is calculated by the following formula:

$${C}_{{2}_{x}} = \frac{{Y}_{ij} - {Y}_{( i + x ) j}}{x} ,$$

where C₂_{ₓ} is the first characteristic value of the original image, x is a number of pixels in the first direction of the original image, Yᵢⱼ is a brightness value of an i^{th} pixel in the first direction and a j^{th} pixel in the second direction of the original image, Y₍ᵢ₊ₓ₎ⱼ is a brightness value of an (i+x)^{th} pixel in the first direction and the j^{th} pixel in the second direction of the original image, and i, j, and x are positive integers.

In the step S120, the second characteristic value of the original image is calculated by the following formula:

$${C}_{{2}_{y}} = \frac{{Y}_{ij} - {Y}_{i ( j + y )}}{y} ,$$

where C₂_{ₓ} is the second characteristic value of the original image, y is a number of pixels in the second direction of the original image, Yᵢⱼ is a brightness value of an i^{th} pixel in the first direction and a j^{th} pixel in the second direction of the original image, Y_{i(j+y)} is a brightness value of an i^{th} pixel in the first direction and a (j+y)^{th} pixel in the second direction of the original image, and i, j, and y are positive integers.

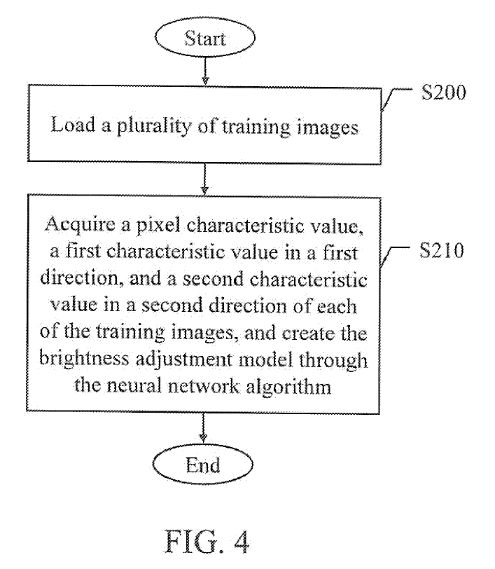

Further, in the step S100, the brightness adjustment model is created in an external device. The external device may be, but not limited to, a computer device of the manufacturer or a computer device in a laboratory. FIG. 4 is a flow chart of creating a brightness adjustment model according to an embodiment of the present invention. The creation process comprises the following steps.

In step S200, a plurality of training images is loaded.

In step S210, a pixel characteristic value, a first characteristic value in a first direction, and a second characteristic value in a second direction of each of the training images are acquired, and the brightness adjustment model is created through the neural network algorithm.

In the step S210, the first direction is different from the second direction, the first direction is a horizontal direction, and the second direction is a vertical direction. Here, the first direction and the second direction can be adjusted according to actual requirements. For example, the two directions may respectively be positive 45° and positive 135° intersected with an X-axis, or positive 30° and positive 150° intersected with the X-axis. However, the acquisition direction of the characteristic value of the original image must be consistent with the acquisition direction of the characteristic value of the training image (i.e., being the same direction).

In the step S210, the pixel characteristic value of each of the training images is calculated by the following formula:

$${C}_{1} = \frac{{Y}_{ij}}{{\sum }_{i = 1}^{N} {\sum }_{j = 1}^{M} \frac{{Y}_{ij}}{N \times M}} ,$$

where C₁ is the pixel characteristic value of each of the training images, N is a total number of pixels in the horizontal direction of each of the training images, M is a total number of pixels in the vertical direction of each of the training images, Yᵢⱼ is a brightness value of an i^{th} pixel in the first direction and a j^{th} pixel in the second direction of each of the training images, and N, M, i, and j are positive integers.

In the step S210, the first characteristic value of each of the training images is calculated by the following formula:

$${C}_{{2}_{x}} = \frac{{Y}_{ij} - {Y}_{( i + x ) j}}{x} ,$$

where C₂_{ₓ} is the first characteristic value of each of the training images, x is a number of pixels in the first direction of each of the training images, Yᵢⱼ is a brightness value of an i^{th} pixel in the first direction and a j^{th} pixel in the second direction of each of the training images, Y₍ᵢ₊ₓ₎ⱼ is a brightness value of an (i+x)^{th} pixel in the first direction and the j^{th} pixel in the second direction of each of the training images, and i, j, and x are positive integers.

In the step S210, the second characteristic value of each of the training images is calculated by the following formula:

$${C}_{{2}_{y}} = \frac{{Y}_{ij} - {Y}_{i ( j + y )}}{y} ,$$

where C₂_{_{y}} is the second characteristic value of each of the training images, y is a number of pixels in the second direction of each of the training images, Yᵢⱼ is a brightness value of an i^{th} pixel in the first direction and a j^{th} pixel in the second direction of each of the training images, Y_{i(j+y)} is a brightness value of an i^{th} pixel in the first direction and a (j+y)^{th} pixel in the second direction of each of the training images, and i, j, and y are positive integers.

The neural network algorithm is a back-propagation neural network (BNN), radial basis function (RBF), or self-organizing map (SOM) algorithm.

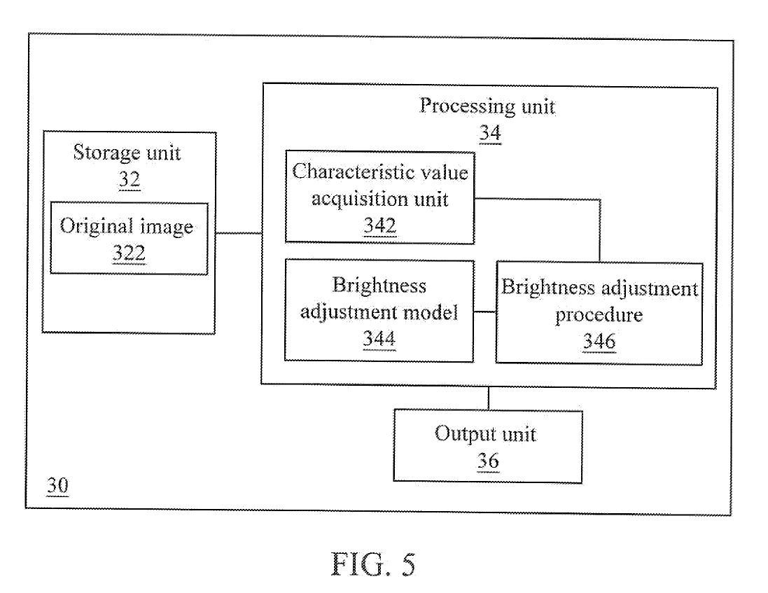

FIG. 5 is a schematic architectural view of an electronic device for generating an HDR image according to another embodiment of the present invention. The electronic device 30 comprises a storage unit 32, a processing unit 34, and an output unit 36. The storage unit 32 stores an original image 322, and may be, but not limited to, a random access memory (RAM), a dynamic random access memory (DRAM), or a synchronous dynamic random access memory (SDRAM).

The processing unit 34 is connected to the storage unit 32, and comprises a brightness adjustment model 344, a characteristic value acquisition unit 342, and a brightness adjustment procedure 346. The characteristic value acquisition unit 342 acquires a pixel characteristic value, a first characteristic value in a first direction, and a second characteristic value in a second direction of the original image 322. The brightness adjustment model 344 is created by a neural network algorithm. The brightness adjustment procedure 346 generates an HDR image through the brightness adjustment model 344 according to the pixel characteristic value, the first characteristic value, and the second characteristic value of the original image 322. The processing unit 34 may be, but not limited to, a central processing unit (CPU) or a micro control unit (MCU). The output unit 36 is connected to the processing unit 34, for displaying the generated HDR image on a screen of the electronic device 30.

The first direction is different from the second direction, the first direction is a horizontal direction, and the second direction is a vertical direction. Here, the first direction and the second direction can be adjusted according to actual requirements. For example, the two directions may respectively be positive 45° and positive 135° intersected with an X-axis, or positive 30° and positive 150° intersected with the X-axis. However, the acquisition direction of the characteristic value of the original image must be consistent with the acquisition direction of the characteristic value of the training image (i.e., being the same direction).

The pixel characteristic value of the original image 322 is calculated by the following formula:

$${C}_{1} = \frac{{Y}_{ij}}{{\sum }_{i = 1}^{N} {\sum }_{j = 1}^{M} \frac{{Y}_{ij}}{N \times M}} ,$$

where C₁ is the pixel characteristic value of the original image 322, N is a total number of pixels in the horizontal direction of the original image 322, M is a total number of pixels in the vertical direction of the original image 322, Yᵢⱼ is a brightness value of an i^{th} pixel in the first direction and a j^{th} pixel in the second direction of the original image 322, and N, M, i, and j are positive integers.

The first characteristic value of the original image is calculated by the following formula:

$${C}_{{2}_{x}} = \frac{{Y}_{ij} - {Y}_{( i + x ) j}}{x} ,$$

where C₂_{ₓ} is the first characteristic value of the original image 322, x is a number of pixels in the first direction of the original image 322, Yᵢⱼ is a brightness value of an i^{th} pixel in the first direction and a j^{th} pixel in the second direction of the original image 322, Y₍ᵢ₊ₓ₎ⱼ is a brightness value of an (i+x)^{th} pixel in the first direction and the j^{th} pixel in the second direction of the original image 322, and i, j, and x are positive integers.

The second characteristic value of the original image 322 is calculated by the following formula:

$${C}_{{2}_{y}} = \frac{{Y}_{ij} - {Y}_{i ( j + y )}}{y} ,$$

where C₂_{_{y}} is the second characteristic value of the original image 322, y is a number of pixels in the second direction of the original image 322, Yᵢⱼ is a brightness value of an i^{th} pixel in the first direction and a j^{th} pixel in the second direction of the original image 322, Y_{i(j+y)} is a brightness value of an i^{th} pixel in the first direction and a (j+y)^{th} pixel in the second direction of the original image 322, and i, j, and y are positive integers.

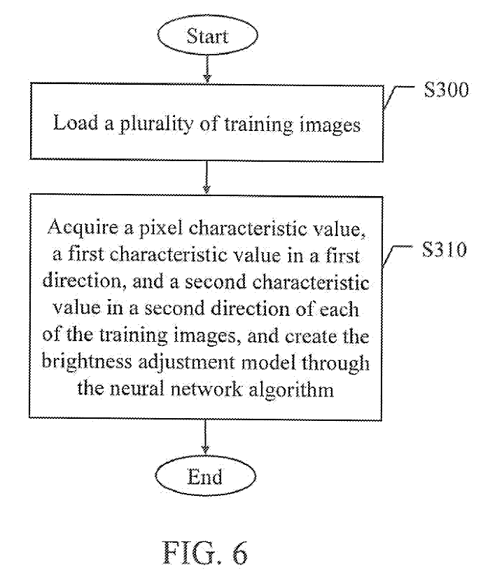

The brightness adjustment model is created in an external device. The external device may be, but not limited to, a computer device of the manufacturer or a computer device in a laboratory. FIG. 6 is a flow chart of creating a brightness adjustment model according to another embodiment of the present invention. The creation process comprises the following steps.

In step S300, a plurality of training images is loaded.

In step S310, a pixel characteristic value, a first characteristic value in a first direction, and a second characteristic value in a second direction of each of the training images are acquired, and the brightness adjustment model is created through the neural network algorithm.

In the step S310, the first direction is different from the second direction, the first direction is a horizontal direction, and the second direction is a vertical direction. Here, the first direction and the second direction can be adjusted according to actual requirements. For example, the two directions may respectively be positive 45° and positive 135° intersected with an X-axis, or positive 30° and positive 150° intersected with the X-axis. However, the acquisition direction of the characteristic value of the original image must be consistent with the acquisition direction of the characteristic value of the training image (i.e., being the same direction).

In the step S310, the pixel characteristic value of each of the training images is calculated by the following formula:

$${C}_{1} = \frac{{Y}_{ij}}{{\sum }_{i = 1}^{N} {\sum }_{j = 1}^{M} \frac{{Y}_{ij}}{N \times M}} ,$$

where C₁ is the pixel characteristic value of each of the training images, N is a total number of pixels in the horizontal direction of each of the training images, M is a total number of pixels in the vertical direction of each of the training images, Yᵢⱼ is a brightness value of an i^{th} pixel in the first direction and a j^{th} pixel in the second direction of each of the training images, and N, M, i, and j are positive integers.

In the step S310, the first characteristic value of each of the training images is calculated by the following formula:

$${C}_{{2}_{x}} = \frac{{Y}_{ij} - {Y}_{( i + x ) j}}{x} ,$$

where C₂_{ₓ} is the first characteristic value of each of the training images, x is a number of pixels in the first direction of each of the training images, Yᵢⱼ is a brightness value of an i^{th} pixel in the first direction and a j^{th} pixel in the second direction of each of the training images, Y₍ᵢ₊ₓ₎ⱼ is a brightness value of an (i+x)^{th} pixel in the first direction and the j^{th} pixel in the second direction of each of the training images, and i, j, and x are positive integers.

In the step S310, the second characteristic value of each of the training images is calculated by the following formula:

$${C}_{{2}_{y}} = \frac{{Y}_{ij} - {Y}_{i ( j + y )}}{y} ,$$

where C₂_{_{y}} is the second characteristic value of each of the training images, y is a number of pixels in the second direction of each of the training images, Yᵢⱼ is a brightness value of an i^{th} pixel in the first direction and a j^{th} pixel in the second direction of each of the training images, Y_{i(j+y)} is a brightness value of an i^{th} pixel in the first direction and a (j+y)^{th} pixel in the second direction of each of the training images, and i, j, and y are positive integers.

The neural network algorithm is a BNN, RBF, or SOM algorithm.

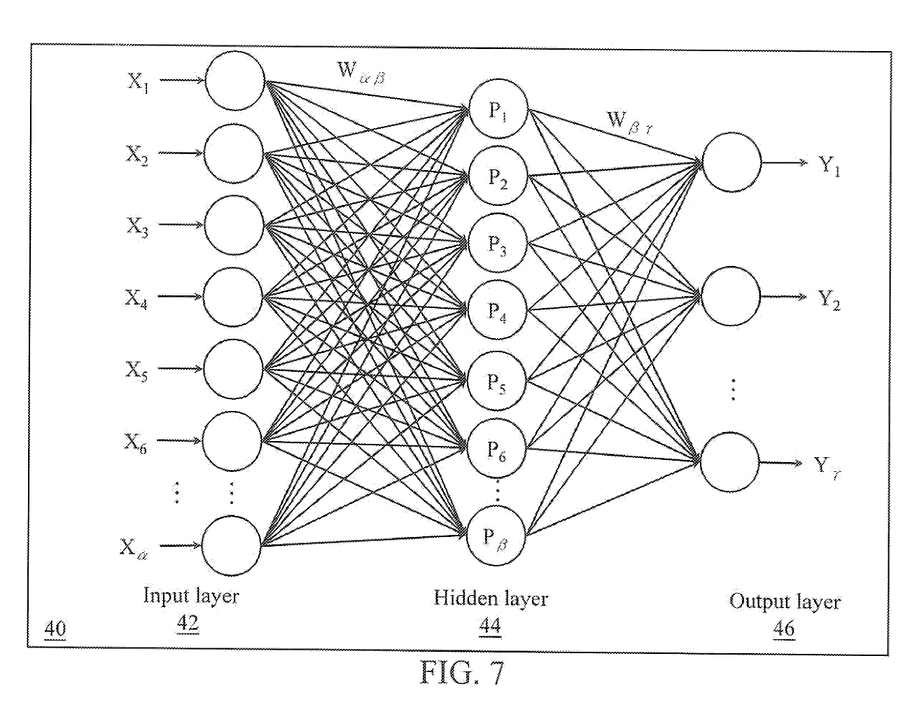

FIG. 7 is a schematic view illustrating the BNN algorithm according to an embodiment of the present invention. The BNN 40 comprises an input layer 42, a hidden layer 44, and an output layer 46. Each of the training images has altogether M*N pixels, and each pixel further has three characteristic values (i.e., a pixel characteristic value, a first characteristic value, and a second characteristic value). The input layer respectively inputs the characteristic values of the pixels in each training image, so that a total number of nodes (X₁, X₂, X₃, . . . , X_{α}) in the input layer 42 is α=3*M*N. A number of nodes (P₁, P₂, P₃, . . . , P_{β}) in the hidden layer 44 is β, a number of nodes (Y₁, Y₂, Y₃, . . . , Y_{γ}) in the output layer 46 is γ, and α β γ. After the BNN algorithm trains and determines the convergence of all the training images, a brightness adjustment model is obtained. A first group of weight values W_{αβ} are obtained between the input layer 42 and the hidden layer 44 of the brightness adjustment model, and a second group of weight values W_{βγ} are obtained between the hidden layer 44 and the output layer 46 of the brightness adjustment model.

The value of each node in the hidden layer 44 is calculated by the following formula:

$${P}_{j} = {\sum }_{i = 1}^{α} ( {X}_{i} \times {W}_{ij} ) + {b}_{j} ,$$

where Pⱼ is a value of a j^{th} node in the hidden layer 44, Xᵢ is a value of an i^{th} node in the input layer 42, Wᵢⱼ is a weight value between the i^{th} node in the input layer 42 and the j^{th} node in the hidden layer 44, bⱼ is an offset of the j^{th} node in the hidden layer 44, and α, i, and j are positive integers.

Further, the value of each node in the output layer 46 is calculated by the following formula:

$${Y}_{k} = {\sum }_{j = 1}^{β} ( {P}_{j} \times {W}_{jk} ) + {c}_{k} ,$$

where Yₖ is a value of a k^{th} node in the output layer 46, Pⱼ is the value of the j^{th} node in the hidden layer 44, Wⱼₖ is a weight value between the j^{th} node in the hidden layer 44 and the k^{th} node in the output layer 46, cₖ is an offset of the k^{th} node in the output layer 46, and β, j, and k are positive integers.

In addition, the convergence is determined by mean squared error (MSE):

$$M S E = \frac{1}{λ \times γ} \times {\sum }_{s}^{λ} {\sum }_{k}^{γ} {( {T}_{k}^{s} - {Y}_{k}^{s} )}^{2} < {10}^{- 10} ,$$

where λ is a total number of the training images, γ is a total number of the nodes in the output layer, Tₖ^{s} is a target output value of the k^{th} node in an s^{th} training image, Yₖ^{s} is a deducted output value of the k^{th} node in the s^{th} training image, and λ, γ, s, and k are positive integers.

What is claimed is:

1. A method of generating a high dynamic range (HDR) image, comprising:
loading a brightness adjustment model created by a neural network algorithm;
obtaining an original image;
acquiring a pixel characteristic value, a first characteristic value in a first direction, and a second characteristic value in a second direction of the original image; and
generating an HDR image through the brightness adjustment model according to the pixel characteristic value, the first characteristic value, and the second characteristic value of the original image.

2. The method of generating an HDR image according to claim 1, wherein the first direction is different from the second direction, the first direction is a horizontal direction, and the second direction is a vertical direction.

3. The method of generating an HDR image according to claim 1, wherein the pixel characteristic value of the original image is calculated by the following formula:
$${C}_{1} = \frac{{Y}_{ij}}{{\sum }_{i = 1}^{N} {\sum }_{j = 1}^{M} \frac{{Y}_{ij}}{N \times M}}$$
where C₁ is the pixel characteristic value of the original image, N is a total number of pixels in the horizontal direction of the original image, M is a total number of pixels in the vertical direction of the original image, Yᵢⱼ is a brightness value of an i^{th} pixel in the first direction and a j^{th} pixel in the second direction of the original image, and N, M, i, and j are positive integers.

4. The method of generating an HDR image according to claim 1, wherein the first characteristic value of the original image is calculated by the following formula:
$${C}_{{2}_{x}} = \frac{{Y}_{ij} - {Y}_{( i + x ) j}}{x}$$
where C₂_{ₓ} is the first characteristic value of the original image, x is a number of pixels in the first direction of the original image, Yᵢⱼ is a brightness value of an i^{th} pixel in the first direction and a j^{th} pixel in the second direction of the original image, Y₍ᵢ₊ₓ₎ⱼ is a brightness value of an (i+x)^{th} pixel in the first direction and the j^{th} pixel in the second direction of the original image, and i, j, and x are positive integers.

5. The method of generating an HDR image according to claim 1, wherein the second characteristic value of the original image is calculated by the following formula:
$${C}_{{2}_{y}} = \frac{{Y}_{ij} - {Y}_{i ( j + y )}}{y}$$
where C₂_{_{y}} is the second characteristic value of the original image, y is a number of pixels in the second direction of the original image, Yᵢⱼ is a brightness value of an i^{th} pixel in the first direction and a j^{th} pixel in the second direction of the original image, Y_{i(j+y)} is a brightness value of an i^{th} pixel in the first direction and a (j+y)^{th} pixel in the second direction of the original image, and i, j, and y are positive integers.

6. The method of generating an HDR image according to claim 1, wherein the brightness adjustment model is created in an external device, and the creation process comprises:
loading a plurality of training images; and
acquiring a pixel characteristic value, a first characteristic value in a first direction, and a second characteristic value in a second direction of each of the training images, and creating the brightness adjustment model through the neural network algorithm.

7. The method of generating an HDR image according to claim 6, wherein the first direction is different from the second direction, the first direction is a horizontal direction, and the second direction is a vertical direction.

8. The method of generating an HDR image according to claim 6, wherein the pixel characteristic value of each of the training images is calculated by the following formula:
$${C}_{1} = \frac{{Y}_{ij}}{{\sum }_{i = 1}^{N} {\sum }_{j = 1}^{M} \frac{{Y}_{ij}}{N \times M}}$$
where C₁ is the pixel characteristic value of each of the training images, N is a total number of pixels in the horizontal direction of each of the training images, M is a total number of pixels in the vertical direction of each of the training images, Yᵢⱼ is a brightness value of an i^{th} pixel in the first direction and a j^{th} pixel in the second direction of each of the training images, and N, M, i, and j are positive integers.

9. The method of generating an HDR image according to claim 6, wherein the first characteristic value of each of the training images is calculated by the following formula:
$${C}_{{2}_{x}} = \frac{{Y}_{ij} - {Y}_{( i + x ) j}}{x}$$
where C₂_{ₓ} is the first characteristic value of each of the training images, x is a number of pixels in the first direction of each of the training images, Yᵢⱼ is a brightness value of an i^{th} pixel in the first direction and a j^{th} pixel in the second direction of each of the training images, Y₍ᵢ₊ₓ₎ⱼ is a brightness value of an (i+x)^{th} pixel in the first direction and the j^{th} pixel in the second direction of each of the training images, and i, j, and x are positive integers.

10. The method of generating an HDR image according to claim 6, wherein the second characteristic value of each of the training images is calculated by the following formula:
$${C}_{{2}_{y}} = \frac{{Y}_{ij} - {Y}_{i ( j + y )}}{y}$$
where C₂_{_{y}} is the second characteristic value of each of the training images, y is a number of pixels in the second direction of each of the training images, Yᵢⱼ is a brightness value of an i^{th} pixel in the first direction and a j^{th} pixel in the second direction of each of the training images, Y_{i(j+y)} is a brightness value of an i^{th} pixel in the first direction and a (j+y)^{th} pixel in the second direction of each of the training images, and i, j, and y are positive integers.

11. The method of generating an HDR image according to claim 1, wherein the neural network algorithm is a back-propagation neural network (BNN), radial basis function (RBF), or self-organizing map (SOM) algorithm.

12. An electronic device for generating a high dynamic range (HDR) image, adapted to perform brightness adjustment on an original image through a brightness adjustment model, the electronic device comprising:
a brightness adjustment model, created by a neural network algorithm;
a characteristic value acquisition unit, for acquiring a pixel characteristic value, a first characteristic value in a first direction, and a second characteristic value in a second direction of the original image; and
a brightness adjustment procedure, connected to the brightness adjustment model and the characteristic value acquisition unit, for generating an HDR image through the brightness adjustment model according to the pixel characteristic value, the first characteristic value, and the second characteristic value of the original image.

13. The electronic device for generating an HDR image according to claim 12, wherein the first direction is different from the second direction, the first direction is a horizontal direction, and the second direction is a vertical direction.

14. The electronic device for generating an HDR image according to claim 12, wherein the pixel characteristic value of the original image is calculated by the following formula:
$${C}_{1} = \frac{{Y}_{ij}}{{\sum }_{i = 1}^{N} {\sum }_{j = 1}^{M} \frac{{Y}_{ij}}{N \times M}}$$
where C₁ is the pixel characteristic value of the original image, N is a total number of pixels in the horizontal direction of the original image, M is a total number of pixels in the vertical direction of the original image, Yᵢⱼ is a brightness value of an i^{th} pixel in the first direction and a j^{th} pixel in the second direction of the original image, and N, M, i, and j are positive integers.

15. The electronic device for generating an HDR image according to claim 12, wherein the first characteristic value of the original image is calculated by the following formula:
$${C}_{{2}_{x}} = \frac{{Y}_{ij} - {Y}_{( i + x ) j}}{x}$$
where C₂_{ₓ} is the first characteristic value of the original image, x is a number of pixels in the first direction of the original image, Yᵢⱼ is a brightness value of an i^{th} pixel in the first direction and a j^{th} pixel in the second direction of the original image, Y₍ᵢ₊ₓ₎ⱼ is a brightness value of an (i+x)^{th} pixel in the first direction and the j^{th} pixel in the second direction of the original image, and i, j, and x are positive integers.

16. The electronic device for generating an HDR image according to claim 12, wherein the second characteristic value of the original image is calculated by the following formula:
$${C}_{{2}_{y}} = \frac{{Y}_{ij} - {Y}_{i ( j + y )}}{y}$$
where C₂_{_{y}} is the second characteristic value of the original image, y is a number of pixels in the second direction of the original image, Yᵢⱼ is a brightness value of an i^{th} pixel in the first direction and a j^{th} pixel in the second direction of the original image, Y_{i(j+y)} is a brightness value of an i^{th} pixel in the first direction and a (j+y)^{th} pixel in the second direction of the original image, and i, j, and y are positive integers.

17. The electronic device for generating an HDR image according to claim 12, wherein the brightness adjustment model is created in an external device, and the creation process comprises:
loading a plurality of training images; and
acquiring a pixel characteristic value, a first characteristic value in a first direction, and a second characteristic value in a second direction of each of the training images, and creating the brightness adjustment model through the neural network algorithm.

18. The electronic device for generating an HDR image according to claim 17, wherein the first direction is different from the second direction, the first direction is a horizontal direction, and the second direction is a vertical direction.

19. The electronic device for generating an HDR image according to claim 17, wherein the pixel characteristic value of each of the training images is calculated by the following formula:
$${C}_{1} = \frac{{Y}_{ij}}{{\sum }_{i = 1}^{N} {\sum }_{j = 1}^{M} \frac{{Y}_{ij}}{N \times M}}$$
where C₁ is the pixel characteristic value of each of the training images, N is a total number of pixels in the horizontal direction of each of the training images, M is a total number of pixels in the vertical direction of each of the training images, Yᵢⱼ is a brightness value of an i^{th} pixel in the first direction and a j^{th} pixel in the second direction of each of the training images, and N, M, i, and j are positive integers.

20. The electronic device for generating an HDR image according to claim 17, wherein the first characteristic value of each of the training images is calculated by the following formula:
$${C}_{{2}_{x}} = \frac{{Y}_{ij} - {Y}_{( i + x ) j}}{x}$$
where C²_{ₓ} is the first characteristic value of each of the training images, x is a number of pixels in the first direction of each of the training images, Yᵢⱼ is a brightness value of an i^{th} pixel in the first direction and a j^{th} pixel in the second direction of each of the training images, Y₍ᵢ₊ₓ₎ⱼ is a brightness value of an (i+x)^{th} pixel in the first direction and the j^{th} pixel in the second direction of each of the training images, and i, j, and x are positive integers.

21. The electronic device for generating an HDR image according to claim 17, wherein the second characteristic value of each of the training images is calculated by the following formula:
$${C}_{{2}_{y}} = \frac{{Y}_{ij} - {Y}_{i ( j + y )}}{y}$$
where C₂_{_{y}} is the second characteristic value of each of the training images, y is a number of pixels in the second direction of each of the training images, Yᵢⱼ is a brightness value of an i^{th} pixel in the first direction and a j^{th} pixel in the second direction of each of the training images, Y_{i(j+y)} is a brightness value of an i^{th} pixel in the first direction and a (j+y)^{th} pixel in the second direction of each of the training images, and i, j, and y are positive integers.

22. The electronic device for generating an HDR image according to claim 17, wherein the neural network algorithm is a back-propagation neural network (BNN), radial basis function (RBF), or self-organizing map (SOM) algorithm.
